(19) United States
(12) Patent Application Publication
(10) Pub. No.: US 2009/0101367 A1
(43) Pub. Date: Apr. 23, 2009

(54) Sprinkler head apparatus

(75) Inventor: Mark Healy, Orlando, FL (US)

Correspondence Address: William M. Hobby, III, 157 E. New England Avenue, #375, Orlando, FL, 32789, US

(73) Assignee: Senninger Irrigation Inc.

(21) Appl. No.: 11/975,602

(22) Filed: Oct. 22, 2007

(51) Int. Cl. A62C 35/00

(52) U.S. Cl. 169/37

(57) ABSTRACT

A rotatable sprinkler head apparatus has a sprinkler body and a sprinkler swivel having attaching means for attaching a rotatable sprinkler head apparatus to a source of water. The swivel has a bore therethrough. A spindle has a bore therethrough and is rotatably mounted through the sprinkler swivel bore and connected at one end to the sprinkler body and having a flange at the opposite end thereof. A washer stack has a plurality of washers thereon mounted around said spindle between said spindle flange and said swivel. The washer stack includes a wear washer having an annular generally external ledge for forming a generally L-shape cross section rotatable with the spindle in an annular generally stationary washer adjacent to the swivel and riding on the wear washer external ledge without touching the spindle so that spindle wear is reduced by the wear washer rotating relative to the generally stationary washer. The washer stack also includes a spindle washer positioned between the wear washer and the spindle flange which rotates with the spindle and the wear washer. The stationary washer as well as the spindle washer is made of an elastomeric material.

### BACKGROUND OF THE INVENTION

1. Field of the Invention

This invention relates to an irrigation sprinkler head and to a sprinkler head washer stack having a plurality of washers.

2. Description of the Prior Art

Rotary head sprinklers, especially the impulse type step-by-step sprinklers, have been used extensively in irrigation of agricultural fields, groves, and the like. In dry seasons, these sprinklers may be used almost continuously to supply the moisture required for proper plant growth. Multiple sprinkler heads are frequently combined into large irrigation systems which are usually elevated above the crops to be irrigated. These irrigation systems may be fed with river, lake or well water.

In the past, attempts have been made to shield the lower bearing seal which separates the spindle and swivel mechanisms to permit the use of ordinary flat washers. A, plurality of washers, called a washer stack, has been used to seal between the rotating spindle and the stationary swivel of a sprinkler head. This washer stack normally includes a flat wear washer sandwiched between two flat softer sealing washers. Water pressure applied to the sprinkler head and spindle flange forces the washers together and against the spindle. This causes the top generally stationary washer to scrub against the rotating spindle, eventually causing wear and shortening the life of the spindle and sprinkler head.

In U.S. Pat. Nos. 3,204,873 and 3,204,874, Senninger uses a single wear washer and a single seal which are both semi-shielded from the water flow. In U.S. Pat. No. 2,904,261 to Johnson, a single wear washer with two seals are used which are both semi-shielded from the water pressure. Costa, et al. U.S. Pat. No. 3,764,073 is for a sprinkler head mounting means and teaches a sprinkler head having sacrificial wear washers and special seals. It has a plastic slip washer having an angular cross section and an axial cylindrical wall.

In my prior U.S. Pat. No. 3,968,934, a sprinkler head bearing means is provided for a rotatable head sprinkler apparatus which incorporates a lower bearing seal having a wear washer and two seals having a generally T-shaped cross section mounted on either side of the wear washer. In my prior U.S. Pat. No. 4,062,494 I provide a sprinkler head sealing apparatus with seals and wear washers in which the wear washer has an angular groove formed in its outer periphery to thereby form a pair of angular ridges. A lower bearing seal has a tapered portion along with an annular lip protruding from its periphery. Epstein et al. U.S. Pat. No. 6,260,770 shows a sealing assembly for three sealing rings, two of which are made out of ceramic material and also has a second resilient ring.

### SUMMARY OF THE INVENTION

A rotatable sprinkler head apparatus has a sprinkler body and a sprinkler swivel having attaching means for attaching a rotatable sprinkler head apparatus to a source of water. The swivel has a bore therethrough. A spindle has a bore therethrough and is rotatably mounted through the sprinkler swivel bore and connected at one end to the sprinkler body and has a flange at the opposite end thereof. A washer stack has a plurality of washers thereon mounted around said spindle between said spindle flange and the end of said swivel. The washer stack includes a wear washer having an annular generally external ledge for forming a generally L-shape cross section rotatable with the spindle and an annular generally stationary washer adjacent to the swivel and riding on the wear washer external ledge without touching the spindle so that spindle wear is reduced by the wear washer rotating relative to the generally stationary washer. The washer stack also includes a spindle washer positioned between the wear washer and the spindle flange which rotates with the spindle and the wear washer. The stationary washer as well as the spindle washer is made of an elastomeric material.

### BRIEF DESCRIPTION OF THE DRAWINGS

Other objects, features, and advantages of the present invention will be apparent from the written description and the drawings in which:

FIG. 1 is a cut away sectional view of a sprinkler head having a washer stack in accordance with the present invention;

FIG. 2 is an exploded view of the washer stack and the spindle and swivel; and

FIG. 3 is a perspective view of a wear washer of the present invention.

### DETAILED DESCRIPTION OF THE PREFERRED EMBODIMENT

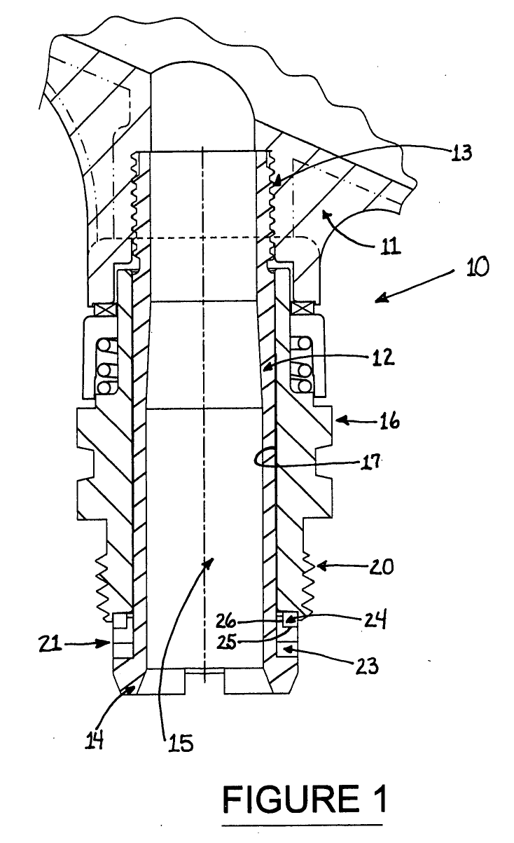

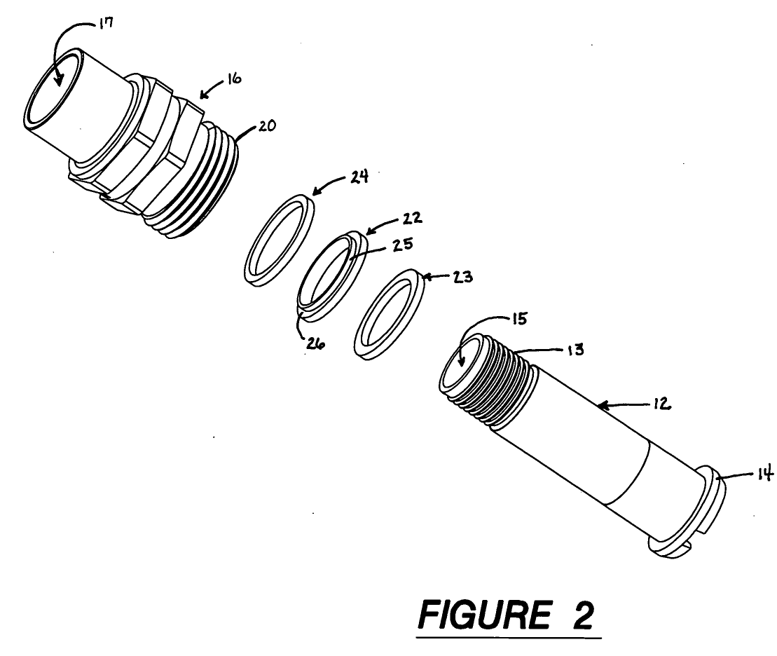

Referring to the drawings of FIGS. 1 through 3, a rotary irrigation sprinkler head 10 has a sprinkler head body 11 having a spindle 12 threadedly attached thereto with threads 13 at one end and having an annular spindle flange 14 at the other end. The spindle 12 has a passageway 15 extending therethrough for the passage of water from a water source. A swivel 16 has a passageway 17 passing therethrough and has a spindle 12 extending through the passageway 17 of the swivel 16. The swivel 16 has external threads 20 for attaching to a water source, such as an irrigation pipe or the like. When the sprinkler head 10 is attached to a water source, water passes through the spindle 15 and into the sprinkler body 11 which distributes the water and causes the sprinkler body and spindle 12 to rotate.

An annular washer stack 21 includes a wear washer 22 and a rotating washer 23 adjacent the flange 14 and rotatable with the spindle 12. A sealing washer 24 is mounted on the other side of the wear washer 22 and abuts against the swivel 20 and against the wear washer 22 but does not contact the spindle 12. The washer 24 is held stationary in its position by the end of the swivel 16. The stationary washer 24, as seen from FIG. 1, does not have contact with the spindle 12.

The wear washer 22 is seen to be an annular washer with a generally L-shaped cross section having a bottom ledge 25 and a side leg 26. The stationary washer 24 rides on the wear washer ledges 25 and 26, as seen in FIG. 1, and has a lap-like connection with the wear washer 22.

In operation the spindle 12 rotates with the sprinkler body 11, the closely fitted wear washer 22 and the spindle washer 23. Washer 24 is held stationary against the swivel and rotates on the wear washer 22 without any contact with the rotating spindle 12. The wear washer 22 is made of a relatively hard wear resistant material, such as TEFLON or an ultrahigh molecular weight polyethylene, while the washers 23 and 24 are made of a rubber or an elastomer, such as neoprene or Nitrile.

In the past, in a standard three-washer sprinkler bearing stack, water pressure forces the stationary top washer to scrub against the rotating spindle and eventually causes wear on the spindle, leakage and eventual destruction of the bearing. By the use of the present L-shaped wear washer 22 and an elastomeric washer 24 rotating against the wear washer 22, the spindle wear is eliminated thus prolonging the life of the sprinkler spindle and sprinkler head.

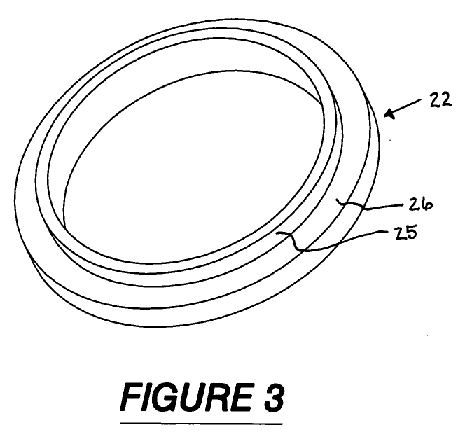

Referring more specifically to FIG. 3, the wear washer 22 is seen having ledges 25 and 26 for the stationary washer 24 to ride upon. The wear washer's wear connection is between the wear washer 22 and the stationary washer 24 and washer 24 has no contact with the rotating spindle 12, thereby prolonging the life of spindle 12.

It should be clear at this point that a rotating sprinkler head has been provided which advantageously reduces the wear on the rotating spindle by the wear washer rotating relative to a generally stationary washer. The present invention however is not to be construed as limited to the particular forms shown which are to be considered illustrative rather than restrictive.

I claim:

1. A rotatable sprinkler head apparatus having:
a sprinkler body;
a sprinkler swivel having attaching means for attaching to a source of water, said swivel having a bore therethrough;
a spindle having a bore therethrough rotatably mounted through said sprinkler swivel bore and connected at one end to said sprinkler body and having a flange at the opposite end thereof;
a washer stack having a plurality of washers thereon mounted around said spindle between said spindle flange and said swivel, said washer stack including a wear washer having an annular generally external ledge forming a generally L-shaped cross-section rotatable with said spindle and an annular generally stationary washer adjacent to said swivel and riding on said wear washer external ledge;
whereby spindle wear is reduced by said wear washer rotating relative to said generally stationary washer.

2. A rotatable sprinkler head apparatus in accordance with claim 1 in which said washer stack includes a spindle washer positioned between said wear washer and said spindle flange.

3. A rotatable sprinkler head apparatus in accordance with claim 2 in which said spindle washer rotates with said spindle.

4. A rotatable sprinkler head apparatus in accordance with claim 3 in which said stationary washer is an elastomeric washer.

5. A rotatable sprinkler head apparatus in accordance with claim 3 in which said stationary washer is made of Nitrile.

6. rotatable sprinkler head apparatus in accordance with claim 4 in which said spindle washer is an elastomeric washer.

7. A rotatable sprinkler head apparatus in accordance with claim 4 in which said spindle washer is made of Nitrile.

8. A rotatable sprinkler head apparatus in accordance with claim 6 in which said spindle washer is a polyethylene washer.

9. A rotatable sprinkler head apparatus in accordance with claim 6 in which said spindle washer is made of ultra high molecular weight polyethylene.
